(19) United States
(12) Patent Application Publication
(10) Pub. No.: US 2015/0261473 A1
(43) Pub. Date: Sep. 17, 2015

(54) MEMORY SYSTEM AND METHOD OF CONTROLLING MEMORY SYSTEM

(71) Applicant: Kabushiki Kaisha Toshiba, Minato-ku (JP)

(72) Inventors: Motohiro MATSUYAMA, Hino (JP); Yoshihisa Kojima, Kawasaki (JP)

(73) Assignee: Kabushiki Kaisha Toshiba, Minato-ku (JP)

(21) Appl. No.: 14/479,508

(22) Filed: Sep. 8, 2014

Related U.S. Application Data
(60) Provisional application No. 61/951,125, filed on Mar. 11, 2014.

(51) Int. Cl. G06F 3/06

(52) U.S. Cl. CPC G06F 3/0625; G06F 3/0679; G06F 3/0659; G06F 2206/1014

(57) ABSTRACT

According to one embodiment, a memory controller includes a front end section and a back end section. The front end section receives commands from a host and returns responses to the commands to the host. The back end section receives the commands from the front end section and has access to a non-volatile memory unit in response to the commands. The front end section controls, on the basis of target performance, a number of the commands which are to be transmitted to the back end section from a queue. The back end section controls the number of commands which are to be input on the basis of a target power consumption value.

### CROSS-REFERENCE TO RELATED APPLICATIONS

This application is based upon and claims the benefit of priority from U.S. Provisional Application No. 61/951,125, filed on Mar. 11, 2014; the entire contents of which are incorporated herein by reference.

### FIELD

Embodiments described herein relate generally to a memory system and a method of controlling the memory system.

### BACKGROUND

A memory system such as an SSD (Solid State Drive) which uses a NAND-type flash memory in a storage medium has a throttling function for drive not with the maximum ability but with ability lower than the maximum ability. As the throttling, there are, for example, the throttling of power for controlling the memory system so that power consumption becomes equal or smaller than target power consumption and the throttling of performance for controlling the number of commands that are received from a host and processed within a predetermined time.

Accordingly, a technique which can optimally satisfy both the target power consumption and the target performance is required.

### BRIEF DESCRIPTION OF THE DRAWINGS

FIG. 1 is a block diagram schematically illustrating an example of the configuration of a memory system according to a first embodiment;

FIG. 2 is a diagram illustrating an example of a performance control table;

FIG. 3 is a diagram illustrating an example of a power control table;

FIG. 4 is a diagram illustrating the concept of control points of the throttling of performance and the throttling of power of the first embodiment;

FIG. 5 is a flowchart illustrating an example of a method of controlling the memory system according to the first embodiment;

FIG. 6 is a diagram illustrating an example of a procedure of target performance control processing;

FIG. 7 is a diagram illustrating an example of a procedure of target power control processing;

FIGS. 8A and 8B are diagrams illustrating an example of the structure of a performance control table of a second embodiment;

FIG. 9 is a block diagram schematically illustrating an example of the configuration of a memory system according to the second embodiment;

FIG. 10 is a block diagram schematically illustrating another example of the configuration of the memory system according to the second embodiment; and

FIG. 11 is a diagram illustrating an example of the structure of a performance control table of a third embodiment.

### DETAILED DESCRIPTION

In general, according to one embodiment, there is provided a memory system that includes a non-volatile memory unit and a memory controller for controlling the non-volatile memory unit. The memory controller includes a front end section and a back end section. The front end section receives commands from a host and returns responses to the commands to the host. The back end section receives the commands from the front end section and has access to the non-volatile memory unit in response to the commands. The front end section includes a queue queuing the commands received from the host. And the front end section controls, on the basis of target performance, a number of the commands which are to be transmitted to the back end section from the queue. The back end section controls the number of commands which are to be input on the basis of a target power consumption value.

Exemplary embodiments of a memory system and a method of controlling the memory system will be explained in detail below with reference to the accompanying drawings. The present invention is not limited to these embodiments.

### First Embodiment

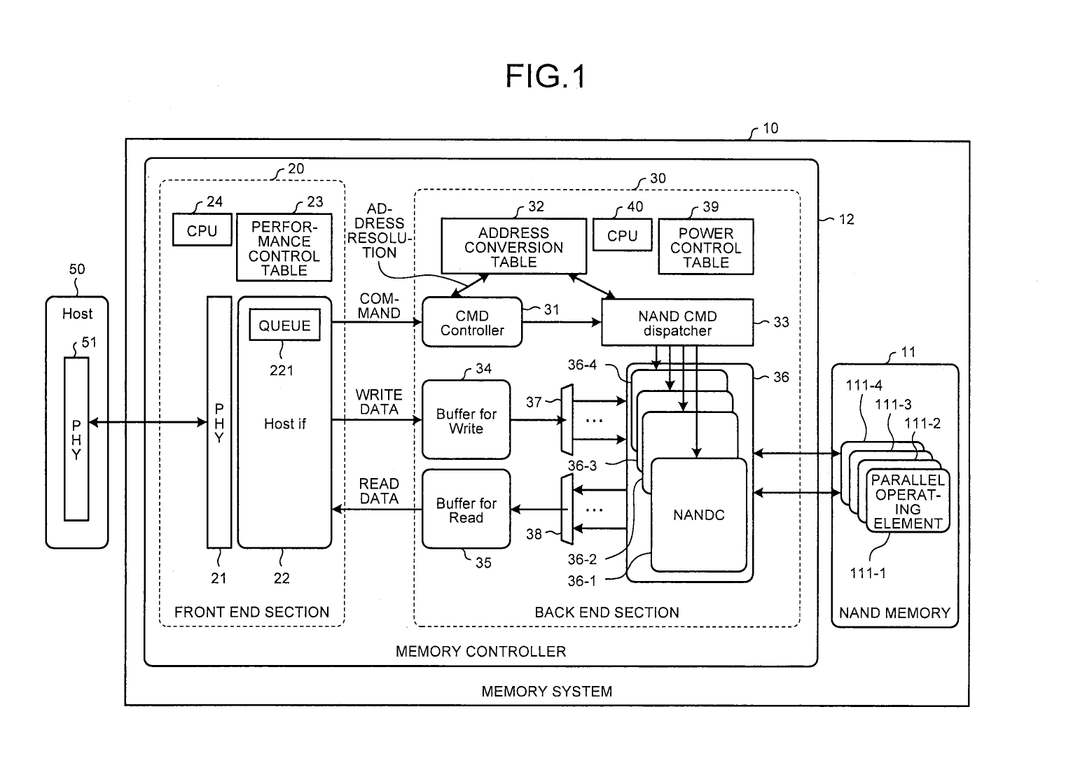

FIG. 1 is a block diagram schematically illustrating an example of the configuration of a memory system according to a first embodiment. The memory system 10 includes a NAND-type flash memory (hereinafter, referred to as a NAND memory) 11 and a memory controller 12.

The NAND memory 11 is a storage medium that can store information in a non-volatile manner. A unit which can be subjected to a write access and a read access in the NAND memory 11 is a page. The minimum unit which is formed of a plurality of pages and can be deleted at once is a block. In the NAND memory 11, a position is managed by, for example, a cluster unit that is smaller than one page. A cluster size is a size that is obtained by multiplying a sector size which is the minimum access unit obtained from a host 50 by a natural number, and is determined so that a size obtained by multiplying a cluster size by a natural number is a page size.

The NAND memory 11 is formed of a plurality of (four in an example of FIG. 1) parallel operating elements 111-1 to 111-4. The parallel operating elements 111-1 to 111-4 are individually connected to a NAND controller 36 through channels, and can individually operate. Each of the parallel operating elements 111-1 to 111-4 is formed of one or more memory chips that can individually operate.

The memory controller 12 performs the writing of data in the NAND memory 11, the reading of data from the NAND memory 11, or the like according to commands that are issued from the host 50. The memory controller 12 includes a front end section 20 and a back end section 30.

The front end section 20 has a function of controlling the host 50. Specifically, the front end section 20 has a function of transmitting commands which are received from the host 50 to the back end section 30 and a function of transferring data on the basis of the commands. Also, the front end section 20 has a function of returning responses to commands to the host 50. The responses are transmitted from the back end section 30. The front end section 20 includes a PHY 21, a host interface 22, a performance control table 23, and a CPU 24.

The PHY 21 corresponds to an input/output unit for the host 50, and exchanges electrical signals between itself and a PHY 51 that corresponds to an input/output unit of the host 50. The host interface 22 performs protocol conversion between the back end section 30 and the host 50, and controls the transmission (sending and receiving) of data, commands, and addresses. The host interface 22 includes a queue 221 that temporarily stores the commands issued from the host 50.

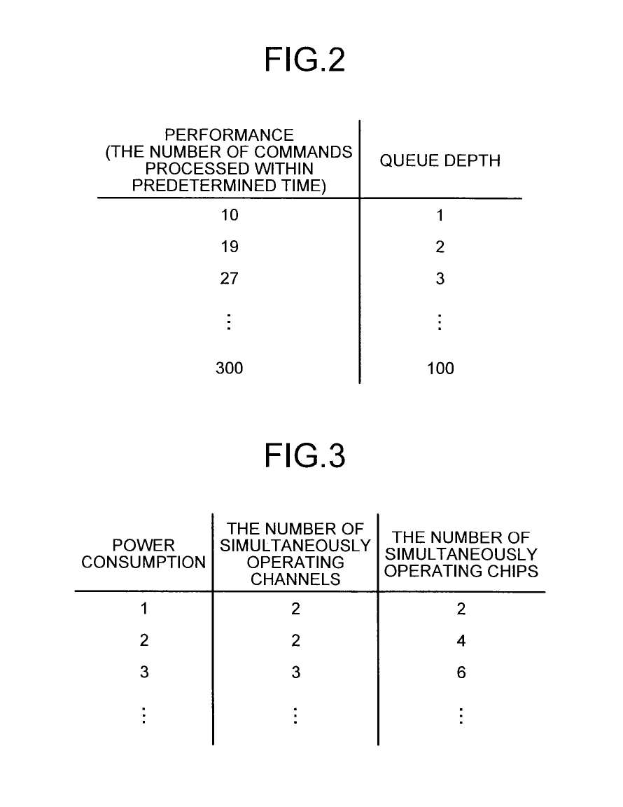

The performance control table 23 stores information that is referred when the throttling of performance is performed. The performance control table is information in which ability (performance) of processing commands in the memory controller 12 is associated with parameters changing the ability. For example, a performance control table in which the number of commands which are issued from the host 50 and can be processed within a predetermined time as performance is associated with the depth (the number of commands that can be held) of the queue 221 of the host interface 22 as a parameter can be used. In this case, performance is improved with the increase of the depth of the queue 221, but performance is saturated when the depth of the queue 221 reaches a certain predetermined value. FIG. 2 is the diagram illustrating an example of the performance control table. As described above, performance and a queue depth are associated with each other in this performance control table. Meanwhile, the performance control table is merely exemplary, and is not limited. Further, throughput meaning the number of commands that are issued from the host 50 and can be processed within a predetermined time, latency meaning a delay time that has passed until a result of transmission is returned after the transmission of data is requested, or the like may be exemplified as performance.

The CPU 24 controls the front end section 20 on the basis of firmware. The CPU 24 adjusts a timing at which commands are transmitted to the back end section 30 from the queue 221 so that a target value corresponding to preset performance is obtained from the state of the queue 221 (the processing states of commands). For example, the front end section 20 acquires a queue depth which allows preset performance to be achieved from the performance control table, and transmits the commands which are received from the host 50 to the back end section 30 so that the queue depth is obtained. When the queue depth does not reach a target queue depth, the front end section 20 transmits the commands to the back end section 30. However, when the queue depth reaches the target queue depth, the front end section 20 temporarily holds the commands without transmitting the commands to the back end section 30 from the queue 221.

The back end section 30 has a function of controlling the NAND memory 11, specifically, a function of writing data in the NAND memory 11 or reading data from the NAND memory 11 on the basis of the commands that are transmitted from the front end section 20. The back end section 30 includes a command controller 31, an address conversion table 32, a NAND command dispatcher 33, a buffer 34 for write, a buffer 35 for read, a NAND controller 36 (four NAND controllers 36-1 to 36-4 in the example of FIG. 1), selectors 37 and 38, a power control table 39, and a CPU 40.

When the command controller 31 receives commands from the front end section 20, the command controller 31 sorts the commands according to the kinds of the commands (whether the command is a write command or a read command, or the like) and transmits the commands to the NAND command dispatcher 33. The address conversion table 32 stores information showing a correspondence relationship between logical addresses which are designated by the commands and physical addresses on the NAND memory 11. The address conversion table is read from the NAND memory 11 at the time of start-up of the memory system 10. When the correspondence relationship between the logical addresses and the physical addresses is changed, the address conversion table is updated on the basis of the contents of the correspondence relationship. The address conversion table is stored on the NAND memory 11 at a predetermined timing (for example, when the supply of power is cut off).

The NAND command dispatcher 33 arranges the commands transmitted from the front end section 20, changes the commands into command that are to be transmitted to the NAND controller 36, and transmits the commands to the NAND controller 36. Specifically, the NAND command dispatcher 33 converts access destination addresses which are indicated by the logical addresses of the received commands into physical addresses by using the address conversion table, and further converts the commands into commands having a format that can be interpreted by the NAND memory 11. Then, the NAND command dispatcher 33 sorts the commands for the respective NAND controllers 36-1 to 36-4 (or the respective chips) on the basis of the physical addresses.

The buffer 34 for write temporarily stores data that are to be written in the NAND memory 11. Write commands are transmitted to the back end section 30 from the front end section 20 and data are also transmitted to the buffer 34 for write at the same time. These data are written by the host interface 22. The buffer 35 for read temporarily stores data that are read from the NAND memory 11. These data are written by the NAND controller 36.

The NAND controller 36 controls the reading or writing of data from or in the NAND memory 11 on the basis of the addresses. For example, when the NAND controller 36 receives write commands from the NAND command dispatcher 33, the NAND controller 36 acquires the written data from the buffer 34 for write in response to the write commands and writes the written data in the NAND memory 11 (the parallel operating elements 111-1 to 111-4). Further, when the NAND controller 36 receives read commands from the NAND command dispatcher 33, the NAND controller 36 reads read data from the NAND memory 11 (the parallel operating elements 111-1 to 111-4) in response to the read commands, and stores the read data in the buffer 35 for read. Meanwhile, the NAND controllers 36-1 to 36-4 are provided in the parallel operating elements 111-1 to 111-4 which form the NAND memory 11 respectively.

When the written data are read from the buffer 34 for write, the selector 37 performs switching on the basis of an instruction from the NAND command dispatcher 33 so that the written data are transmitted to the NAND controller 36 performing writing. Furthermore, when the read data are written in the buffer 35 for read from the NAND controller 36, the selector 38 performs switching on the basis of an instruction from the NAND command dispatcher 33 so that the read data are transmitted to the buffer 35 for read from a target NAND controller 36.

The power control table 39 stores information in which the power consumption of the memory controller 12 is associated with parameters changing the power consumption. For example, the number of the parallel operating elements 111-1 to 111-4 which are simultaneously operated (hereinafter, referred to as the number of simultaneously operating channels) as a parameter can be used. Further, as a parameter, the number of memory chips which are simultaneously operated (referred to as the number of simultaneously operating chips) of the parallel operating elements 111-1 to 111-4 may further be added in addition to the number of simultaneously operating channels. FIG. 3 is a diagram illustrating an example of the power control table. Here, the number of simultaneously operating channels and the number of simultaneously operating chips are used as parameters. Furthermore, the power control table shows a correspondence relationship between these parameters and power consumption. Meanwhile, the power control table is merely exemplary, and is not limited. For example, performance may be used instead of power consumption. This uses the fact that power consumption is generally proportional to performance when it is difficult to accurately measure power consumption by the memory system 10.

The CPU 40 adjusts the processing of commands which are transmitted to the NAND controller 36 from the NAND command dispatcher 33 on the basis of firmware. Here, the adjustment is performed by using the power control table so that a target value corresponding to preset power consumption is obtained. For example, the CPU 40 acquires the number of simultaneously operating chips and the number of simultaneously operating channels for allowing preset performance to be achieved and gives an instruction to the NAND command dispatcher 33 so that the number of simultaneously operating channels and the number of simultaneously operating chips are obtained. Further, the NAND command dispatcher 33 adjusts the commands to be transmitted to the NAND controller 36 so that the commands are executed on the basis of the instruction. Peak power is controlled with a time difference during the issue of commands so that the simultaneous operation of the channels or the simultaneous operation of the chips in addition to the simultaneous operation of the channels is avoided as described above.

Furthermore, when, for example, the read commands are processed, the CPU 40 may monitor the vacancy of the buffer 35 for read and control commands to be input to the NAND controller 36 from the NAND command dispatcher 33 on the basis of firmware. The buffer 35 for read temporarily stores data read from the NAND memory 11. The reason for this is that the vacancy of the buffer 35 for read is a control condition for the input of a command to the next NAND controller 36 from the NAND command dispatcher 33.

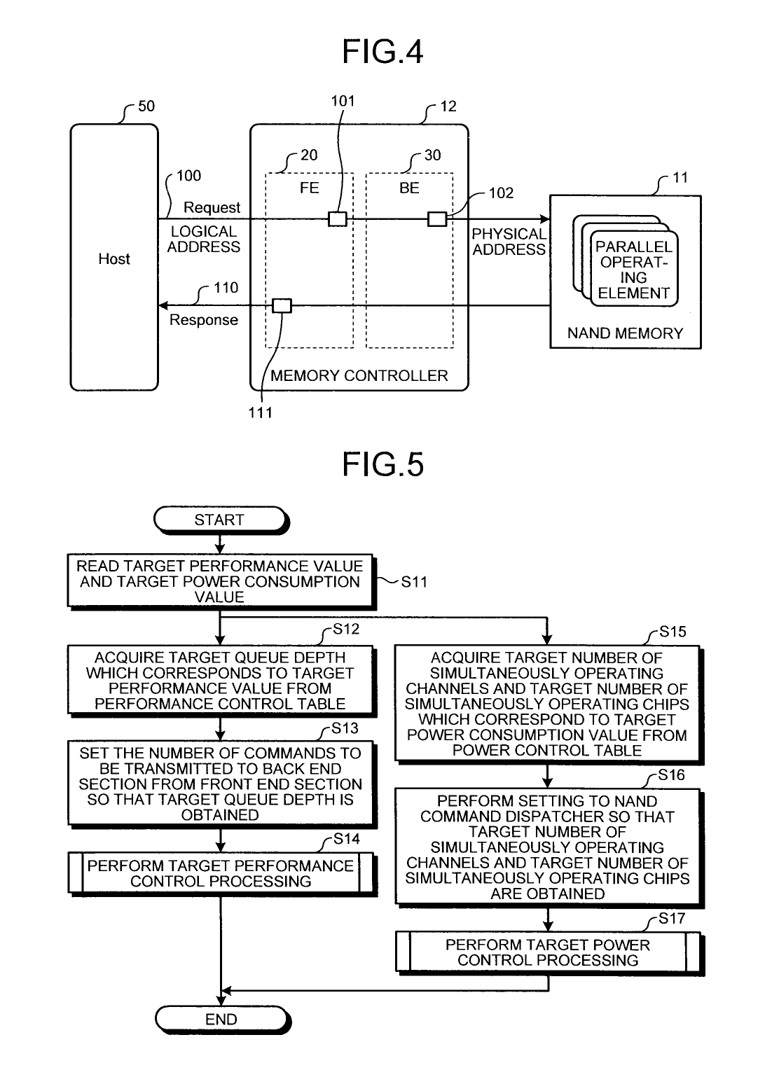

FIG. 4 is a diagram illustrating the concept of control points of the throttling of performance and the throttling of power of the first embodiment. It is preferable that the throttling of performance be controlled at a control point 101 positioned near an outlet of the front end section 20 facing the back end section 30 on a path 100 along which commands issued from the host 50 flow. For example, the queue 221 of the host interface 22 can be used as the control point 101.

The performance of the entire memory system 10 depends on the number of commands that are processed within a predetermined time as described above, but is limited by the depth of the queue in the memory controller 12. The front end section 20 is capable of observing the number of commands that are in a standby state in the queue 221. For this reason, since the number of commands which are transmitted from the queue 221 is controlled by the front end section 20, it is possible to obtain performance that is close to desired performance.

It is preferable that the throttling of power be controlled at a control point 102 positioned near an outlet of the back end section 30 facing the NAND memory 11 on the path 100 along which commands issued from the host 50 flow. The reason for this is that a probability that required accuracy cannot be obtained is high even though the throttling of power is performed by the front end section 20. In the front end section 20, processing is performed in the space of the logical address. For this reason, the front end section 20 cannot know a physical address of the NAND memory 11 as for a read or write command designated by a certain logical address. As a result, since the number of the parallel operating elements which are operated by the execution of the read or write command among the parallel operating elements 111-1 to 111-4 and the number of the chips which are operated by the execution of the read or write command are unclear, it is very difficult to perform the throttling of power.

In contrast, since the back end section 30 is a portion that directly transmits commands to the NAND memory 11, the back end section 30 can grasp the number of simultaneously operating channels and the number of simultaneously operating chips that are required for the execution of the command. Accordingly, it is easy for the back end section 30 to obtain information about power consumption. For this reason, it is preferable to perform control near the outlet of the back end section 30 facing the NAND memory 11 in order to perform the throttling of power. Accordingly, it is possible to perform accurate control as compared to a case in which control is performed in the front end section 20 so that power corresponding to a target value is obtained. For example, the NAND command dispatcher 33 can be used as the control point 102.

Next, the processing of the throttling of performance and power in the memory system 10 having this configuration will be described. FIG. 5 is a flowchart illustrating an example of a method of controlling the memory system according to the first embodiment. Meanwhile, a target performance value and a target power consumption value are preset in the memory system 10. The target performance value and the target power consumption value are set according to a user's desire. The target performance value is set according to, for example, an intention for allowing performance which is obtained after the memory system 10 has been used for a certain period to be not so inferior to performance that is obtained immediately after the use of the memory system 10. The target power consumption value means a value of the maximum power that may be consumed by the memory system 10. Further, the following processing is performed on the basis of firmware by the CPU 24 and the CPU 40.

First, the CPU 24 of the front end section 20 and the CPU 40 of the back end section 30 read the target performance value and the target power consumption value on the basis of firmware at the time of, for example, the start-up of the memory system 10 (Step S11). After that, the CPU 24 of the front end section 20 acquires a queue depth which corresponds to the acquired target performance value (hereinafter, referred to as a target queue depth) from the performance control table (Step S12) and sets the number of commands to be transmitted to the back end section 30 from the front end section 20 so that the number of commands stored in the queue 221 corresponds to the target queue depth (Step S13). Further, target performance control processing is performed in the front end section 20 so that the target performance value is obtained (Step S14).

The CPU 40 of the back end section 30 acquires, on the basis of firmware, a target number of simultaneously operating channels and a target number of simultaneously operating chips from the power control table in parallel with Steps S12 to S14 (Step S15). The target number of simultaneously operating channels and the target number of simultaneously operating chips are determined not to exceed the target power consumption value read at Step S11. After that, an access to the NAND memory 11 which is performed by the NAND controller 36 performs setting to the NAND command dispatcher 33 so that the target number of simultaneously operating channels and the target number of simultaneously operating chips are obtained (Step S16). Further, target power control processing is performed by the back end section 30 (NAND command dispatcher 33) so that the target number of simultaneously operating channels and the target number of simultaneously operating chips are obtained (Step S17). Processing is ended after Step S14 and Step S17.

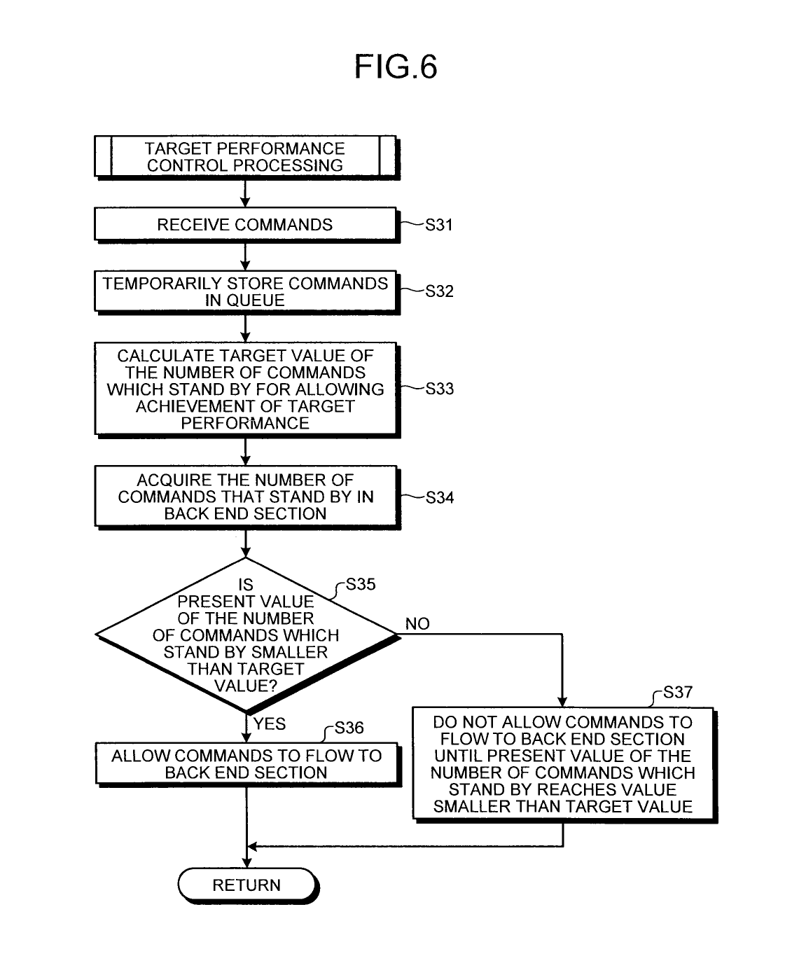

FIG. 6 is a diagram illustrating an example of a procedure of the target performance control processing. Here, a case of a read command will be described by way of example. Further, the following processing is performed on the basis of firmware by the CPU 24. When the front end section 20 receives read commands from the host 50 (Step S31), the CPU 24 of the front end section 20 temporarily stores the received read commands in the queue 221 (Step S32). After that, the CPU 24 calculates a target value of the number of commands which stand by for allowing the achievement of target performance (Step S33), and acquires the number of commands that stand by in the back end section 30 (Step S34). The CPU 24 compares the present value of the number of commands which stand by with a target value thereof, and determines whether or not the present value of the number of commands which stand by is smaller than the target value (Step S35).

If the present value of the number of commands which stand by is smaller than the target value (Yes in Step S35), the CPU 24 allows the commands which are stored in the queue 221 to flow to the back end section 30 so that a queue depth corresponding to target performance is obtained (Step S36) and processing is ended. Meanwhile, if the present value of the number of commands which stand by is equal to or larger than the target value (No in Step S35), the CPU 24 does not allow the commands to flow to the back end section 30 until the present value of the number of commands which stand by reaches the target value (Step S37) and processing is ended.

Meanwhile, the target performance control processing illustrated in FIG. 6 is merely exemplary, and is not limited. For example, after the CPU 24 stores commands in the queue 221 and a predetermined time has passed, the CPU 24 may allow the commands to flow to the back end section 30. Further, the CPU 24 may determine whether or not to allow commands to flow to the back end section 30 while viewing the number of simultaneously operating channels and the number of simultaneously operating chips of the back end section 30. Furthermore, the CPU 24 may count the number of commands that pass within a predetermined time, and may determine whether or not to allow commands to flow to the back end section 30 so that the number of commands passing becomes equal to or smaller than a predetermined value within a predetermined time. Moreover, the CPU 24 may control the timing of a response that returns to the host 50 from the front end section 20. This uses, for example, the fact that commands are not issued from the host 50 any more when a predetermined number of commands are in a standby state in the memory system 10. Accordingly, the number of commands which are standing by in the memory system 10 is controlled. As a result, the throttling of performance can be performed.

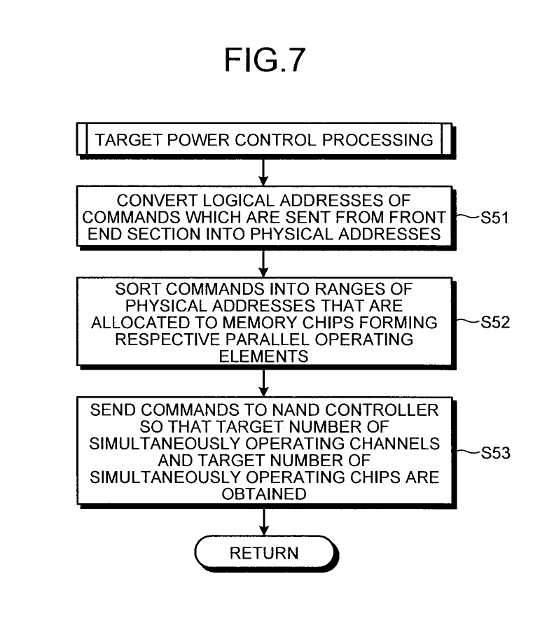

FIG. 7 is a diagram illustrating an example of a procedure of the target power control processing. Here, a case of a read command will be described by way of example. The NAND command dispatcher 33 of the back end section 30 converts logical addresses of access destinations of the read commands into physical addresses by using the address conversion table (Step S51). The read commands are transmitted from the front end section 20. After that, the NAND command dispatcher 33 sorts the read commands into the respective ranges of the physical addresses which are allocated to the memory chips forming the respective parallel operating elements 111-1 to 111-4 by using the converted physical addresses (Step S52). Then, the NAND command dispatcher 33 transmits the read commands to the NAND controller 36 so that the target number of simultaneously operating channels and the target number of simultaneously operating chips acquired in Step S15 are obtained (Step S53). Further, the sorted read commands are executed by the NAND controller 36, data are read from the parallel operating elements 111-1 to 111-4, and the read data are stored on the buffer 35 for read. Accordingly, processing is ended.

Here, setting associated with a control target, such as whether or not power consumption (peak power) should not exceed the target power consumption value even for an instant or whether or not average power consumption within a predetermined period has only to be within a target power value although power consumption may exceed the target power consumption value only for an instant, may also be performed to the memory system 10. In that case, the NAND command dispatcher 33 controls the commands which are to be transmitted to the NAND controller 36 so as to satisfy setting associated with a control target. For example, if peak power should not exceed the target power consumption value even for an instant, the NAND command dispatcher 33 performs processing on the basis of the target number of simultaneously operating channels and the target number of simultaneously operating chips. Further, if average power consumption within a predetermined period has only to be within a target power consumption value, the NAND command dispatcher 33 performs the processing of commands by using the target number of simultaneously operating channels and the target number of simultaneously operating chips corresponding to the target power consumption value and the number of simultaneously operating channels and the target number of simultaneously operating chips close to the target power consumption value so that average power consumption within a predetermined period is equal to or smaller than the target power consumption value.

Meanwhile, a case in which the target queue depth corresponding to target performance is acquired in the front end section 20 from the performance control table according to an instruction from the CPU 24 and the target number of simultaneously operating channels and the target number of simultaneously operating chips corresponding to target power are acquired in the back end section 30 from the power control table according to an instruction from the CPU 40 has been disclosed in the above description. However, these instructions may not be instructions from the CPU 24 and the CPU 40 and may be instructions from the host 50.

According to the first embodiment, the throttling of performance and the throttling of power have been performed at different points in the memory controller 12. Specifically, as for the throttling of performance, the number of commands to be transmitted to the back end section 30 from the front end section 20 has been controlled so that a target queue depth corresponding to preset target performance is obtained. Independently of this, as for the throttling of power, the number of channels and the number of memory chips, when the NAND controller 36 has access to the NAND memory 11, have been controlled so that the target number of simultaneously operating channels and the target number of simultaneously operating chips corresponding to preset target power consumption are obtained. Accordingly, it is possible to operate the memory system 10 so that both the performance and power of the memory system 10 are optimally satisfied. As a result, it is possible to provide a memory system 10 that can flexibly cope with user's needs for usage, such as a method of using the memory system 10 that achieves low power consumption while achieving, for example, the compatibility with old models of a memory system realized by the throttling of performance, the suppression of a difference in performance between a new product and a product having reached the end of life, and the suppression of a difference between products, or a method of operating the memory system 10 at the highest performance after keeping a budget for power consumption.

### Second Embodiment

In the first embodiment, the flow of commands to the back end section has been controlled in the front end section and the number of simultaneously operating channels and the number of simultaneously operating chips have been controlled in the back end section so that target performance and target power consumption set in the memory system are obtained. A case in which control to be performed in a front end section is performed on the basis of the state of a response transmitted to a host will be described in a second embodiment.

As in the first embodiment, the throttling of performance is performed at a control point 101 and the throttling of power is performed at a control point 102 as illustrated in FIG. 4 even in the second embodiment. However, in the second embodiment, responses transmitted to a host 50 are monitored at a point 111 positioned near an outlet of a front end section 20 facing the host 50 on a path 110 along which responses to commands flow. The monitoring of the responses which are transmitted to the host 50 is performed on the basis of firmware by a CPU 24 of a front end section 20.

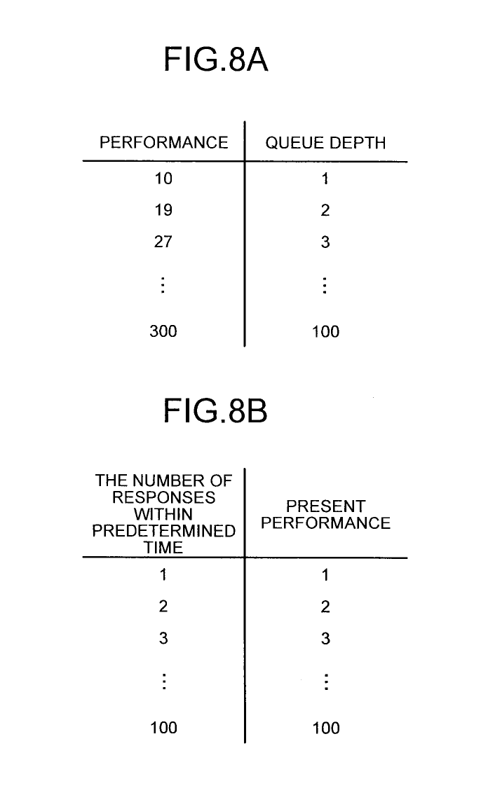

A memory system 10 according to the second embodiment is different from the first embodiment in terms of the functions of a performance control table 23 and the CPU 24. FIGS. 8A and 8B are diagrams illustrating an example of the structure of the performance control table of the second embodiment. As illustrated in FIGS. 8A and 8B, the performance control table 23 includes a performance state acquisition table in addition to a performance control table. FIG. 8A is a diagram illustrating an example of the performance control table. Since the performance control table is the same as the performance control table described in the first embodiment, the description thereof will be omitted. FIG. 8B is a diagram illustrating an example of the performance state acquisition table. The performance state acquisition table is information in which the states of responses transmitted to the host 50 in the front end section 20 (the number of responses within a predetermined time) are associated with a relationship with the performance of the memory system 10 at that time.

Further, the CPU 24 of the front end section 20 monitors, on the basis of firmware, responses which are transmitted to the host 50 and controls the number (timing) of commands which flow to a back end section 30 from a queue 221 on the basis of the results of the monitoring. Specifically, the CPU 24 monitors the number of responses which are transmitted to the host 50 within a predetermined time on the basis of firmware, and acquires the present performance of the present memory system 10 corresponding to the number of the responses. Further, the CPU 24 compares the present performance with the preset target performance. The CPU 24 may perform control the number of commands transmitted to the back end section 30 from the queue 221 so that a queue depth is reduced to obtain the target performance when the present performance is higher than the target performance, and, conversely, a queue depth is increased to obtain the target performance when the present performance is lower than the target performance. Meanwhile, since other configuration is the same as that of the first embodiment, the description thereof will be omitted. Furthermore, since a method of controlling the memory system 10 according to the second embodiment is also the same as that according to the first embodiment, the description thereof will be omitted.

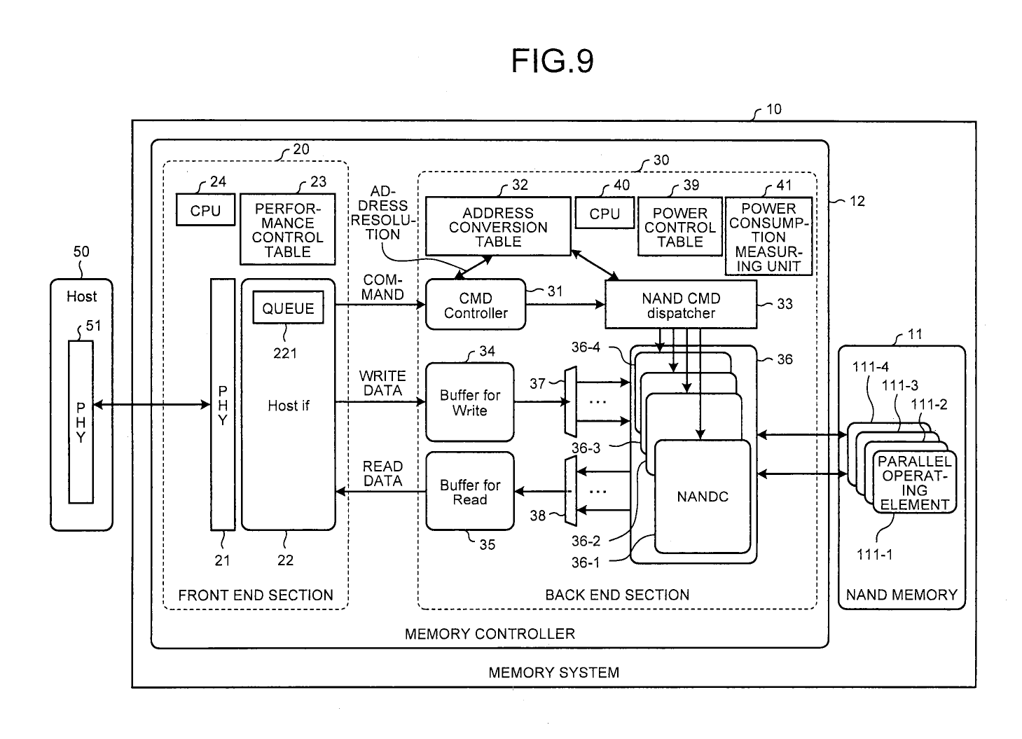

In the above description, the feedback control of the throttling of performance has been performed by the monitoring of the number of responses that are transmitted to the host 50 from the front end section 20. Even as for the throttling of power, the power consumption of the memory system 10 is monitored and the feedback control of the commands which are transmitted to the NAND controller 36 from the NAND command dispatcher 33 can be performed on the basis of the results of the monitoring. FIG. 9 is a block diagram schematically illustrating an example of the configuration of the memory system according to the second embodiment. The memory system 10 further includes a power consumption measuring unit 41 that is provided in the back end section 30 and measures the power consumption of the memory system 10. Meanwhile, the same components as those of the first embodiment will be denoted by the same reference numerals, and the description will be omitted.

In a control method in this case, first, the CPU 40 acquires the present power consumption from the power consumption measuring unit 41 of the memory system 10 on the basis of firmware and compares the present power consumption with target power. The CPU 40 may perform control so that at least one of the number of simultaneously operating channels and the number of simultaneously operating chips is reduced when the present power consumption is higher than the target power, and conversely, at least one of the number of simultaneously operating channels and the number of simultaneously operating chips is increased when the present power consumption is lower than the target power.

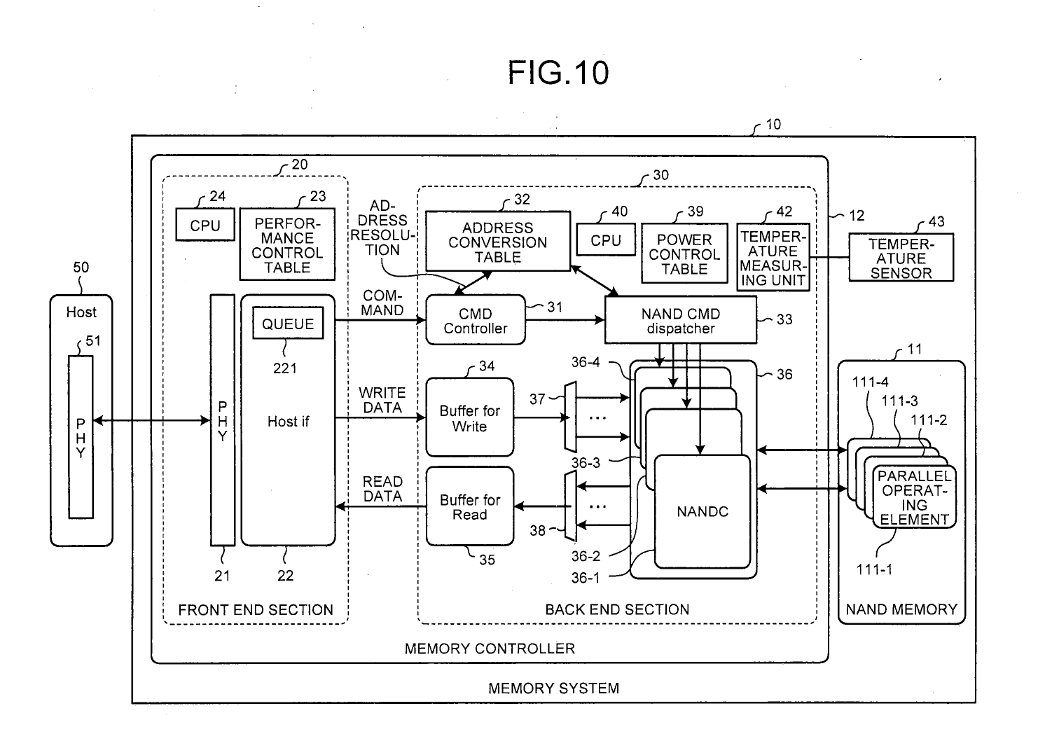

Meanwhile, there is also a case in which it is difficult to measure the power consumption of the memory system 10. In this case, the feedback control of the combination of temperature and the present performance and power consumption can be also performed using the fact that the combination of temperature and the present performance and power consumption correlate with each other to some extent. FIG. 10 is a block diagram schematically illustrating another example of the configuration of the memory system according to the second embodiment. The memory system 10 further includes a temperature sensor 43 that detects the temperature of the memory system 10, and a temperature measuring unit 42 that is provided in the back end section 30 and measures the temperature of the memory system 10 from a signal detected by the temperature sensor 43. Further, a power state estimation table in which the combination of the temperature of the memory system 10 and the present performance is associated with power consumption is provided in the power control table 39 in addition to a power control table.

In a control method in this case, first, the CPU 40 acquires the present temperature from the temperature measuring unit 42 of the memory system 10 and the CPU 24 of the front end section 20 acquires the present performance from the number of responses which are transmitted to the host 50 within a predetermined time by using the performance state acquisition table. The present power which corresponds to the combination of the present temperature and the present performance is acquired from the power state estimation table. That is, a dynamic component (which is switching power or the like and is power also including the NAND memory 11 and the like as well as the memory controller 12) of power is estimated on the basis of the present performance obtained from the number of responses that are output to the host 50 from the front end section 20 and monitored, leakage power (static component) of power is estimated on the basis of the present temperature that is measured by the temperature measuring unit 42, and the present power is estimated from both the dynamic component and the static component of the power. Alternatively, a dynamic component of power may be estimated on the basis of the present number of simultaneously operating channels (the number of simultaneously operating chips may be further added to the present number of simultaneously operating channels), leakage power of power may be estimated on the basis of the present temperature that is measured by the temperature measuring unit 42, and the present power may be estimated from both the dynamic component and the leakage power of the power. Further, the present power is compared with target power. Control may be performed so that at least one of the number of simultaneously operating channels and the number of simultaneously operating chips is reduced when the present power is larger than the target power, and conversely, at least one of the number of simultaneously operating channels and the number of simultaneously operating chips is increased when the present power is smaller than the target power. Meanwhile, leakage power generally depends on temperature, and time is taken until temperature falls. For this reason, it is preferable that temperature and a difference in time until temperature falls are considered in the estimation of leakage power.

In the second embodiment, the number of responses which are transmitted to the host 50 from the front end section 20 within a predetermined period has been monitored. The present performance has been acquired from the number of responses by using the performance state acquisition table. And the timing of the commands which are transmitted to the back end section 30 has been controlled by the CPU 24 of the front end section 20 through the comparison between the present performance and the target performance. Further, the power consumption of the back end section 30 has been estimated. And at least one of the number of simultaneously operating channels and the number of simultaneously operating chips has been controlled so that a gap between the target power consumption value and the present power consumption is bridged. Accordingly, the second embodiment has an effect capable of performing the more accurate throttling of performance than that of the first embodiment.

### Third Embodiment

In the first embodiment, the flow of commands to the back end section has been controlled in the front end section and the number of simultaneously operating channels and the number of simultaneously operating chips have been controlled in the back end section so that target performance and target power consumption set in the memory system are obtained. A case in which the throttling of performance is performed by the control of the timing of responses returning to a host from a front end section will be described in a third embodiment.

In the third embodiment, in FIG. 4, a control point of the throttling of performance is performed at the point 111 positioned near an outlet of the front end section 20 facing the host 50 on the path 110 along which responses to commands transmitted to the host 50 from the NAND memory 11 flow, and the throttling of power is performed at the control point 102. Further, responses transmitted to the host 50 are monitored at the point 111 as in the second embodiment.

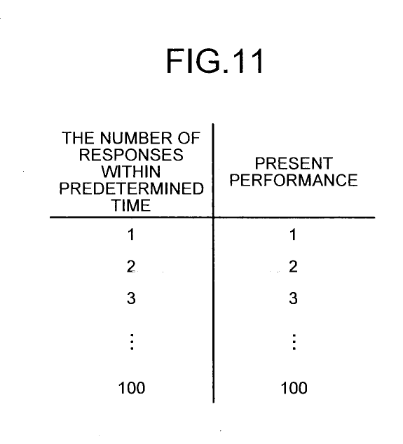

A memory system 10 according to the third embodiment is different from the first embodiment in terms of the functions of a performance control table 23 and a CPU 24. FIG. 11 is a diagram illustrating an example of the structure of the performance control table of the third embodiment. As illustrated in FIG. 11, the performance control table 23 includes a performance state acquisition table as a performance control table. The performance state acquisition table is information in which the states of responses transmitted to the host 50 in the front end section 20 (the number of responses within a predetermined time) are associated with a relationship with the performance of the memory system 10 at that time.

The CPU 24 of the front end section 20 monitors responses which are transmitted to the host 50 on the basis of firmware and acquires the number of responses within a predetermined time. Further, the CPU 24 acquires the present performance from the number of responses within a predetermined time by using the performance state acquisition table. Further, the CPU 24 compares the present performance with target performance. When the present performance is lower than the target performance, the CPU 24 of the front end section 20 performs processing for increasing the number of responses within a predetermined time so that the target performance is obtained. Furthermore, when the present performance is higher than the target performance, the CPU 24 of the front end section 20 performs processing for reducing the number of responses within a predetermined time so that the target performance is obtained. Since performance is directly determined according to the number of responses that return from the memory system 10 within a unit time, it is possible to directly throttle performance by returning responses to the host 50 while intentionally delaying responses in (the front end section 20 of) the memory system 10. Meanwhile, since other configuration is the same as that of the first embodiment, the description thereof will be omitted. Moreover, since a method of controlling the memory system 10 according to the third embodiment is also the same as that according to the first embodiment, the description thereof will be omitted.

In the third embodiment, the number of responses which are transmitted to the host 50 from the front end section 20 of the memory system 10 within a predetermined time has been monitored. And the timing of responses which return to the host 50 from the front end section 20 has been controlled so that the number of responses with in the predetermined time, that is, the present performance becomes the target performance. Accordingly, an effect which can directly throttle the performance of the memory system 10 with a high accuracy is obtained.

Meanwhile, a case of the read command has been described above, but the same processing can be performed even in the case of a write command.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a non-volatile memory unit; and
a memory controller that controls the non-volatile memory unit,
wherein the memory controller includes a front end section and a back end section, the front end section receiving commands from a host and returning responses to the commands to the host, the back end section receiving the commands from the front end section and accessing to the non-volatile memory unit in response to the commands,
the front end section includes a queue queuing the commands received from the host, and controls, on the basis of target performance, a number of the commands which are to be transmitted to the back end section from the queue, and
the back end section controls the number of commands which are to be input on the basis of a target power consumption value.

2. The memory system according to claim 1,
wherein the front end section includes performance control information in which performance of the memory system is associated with the number of the commands to be held in the queue, calculates a target value of the number of commands which stand by for achieving the target performance using the performance control information, and controls, on the basis of the target value, the number of the commands which are to be transmitted to the back end section from the host.

3. The memory system according to claim 1,
wherein the non-volatile memory unit includes a plurality of parallel operating elements that are capable of being individually operated, and
the back end section includes power control information in which power consumption of the memory system is associated with the number of the parallel operating elements capable of being simultaneously operated, calculates a first element number which is the number of the parallel operating elements simultaneously operated and corresponds to the target power in the power control information, and controls an input of the commands so that the number of the parallel operating elements simultaneously operated is equal to or smaller than the first element number.

4. The memory system according to claim 3,
wherein the back end section estimates present power consumption that includes a dynamic component of power consumption estimated on the basis of present performance of the memory system obtained from results of monitoring of the number of the responses returning to the host in the front end section or on the basis of the number of the parallel operating elements being presently and simultaneously operated in the memory system, and controls the input of the commands to the parallel operating elements using the estimated power consumption value on the basis of the power control information.

5. The memory system according to claim 4,
wherein the back end section further estimates leakage power of the power consumption according to temperature of the memory system, and estimates the present power consumption by adding the leakage power to the dynamic component of the power consumption.

6. The memory system according to claim 3,
wherein the parallel operating elements have a plurality of chips that are capable of being individually operated, respectively,
in the power control information, the power consumption of the memory system is associated with the number of the plurality of parallel operating elements capable of being simultaneously operated and the number of the plurality of chips capable of being simultaneously operated, and
the back end section controls the input of the commands to the plurality of parallel operating elements on the basis of the power control information so that the number of the plurality of parallel operating elements to be operated and the number of the plurality of chips to be operated are equal to or smaller than the number of the plurality of parallel operating elements simultaneously operated and the number of plurality of chips simultaneously operated, which correspond to the target power.

7. The memory system according to claim 6,
wherein the back end section estimates present power consumption that includes a dynamic component of power consumption estimated on the basis of present performance of the memory system obtained from results of monitoring of the number of the responses returning to the host in the front end section or on the basis of the number of the parallel operating elements being presently and simultaneously operated and the number of chips being presently and simultaneously operated in the memory system, and controls the input of the commands to the parallel operating elements using the estimated power consumption value on the basis of the power control information.

8. The memory system according to claim 7,
wherein the back end section further estimates leakage power of the power consumption according to temperature of the memory system, and estimates the present power consumption by adding the leakage power to the dynamic component of the power consumption.

9. The memory system according to claim 1,
wherein the front end section monitors the responses returning to the host, determines present performance by the number of the responses within a predetermined time, and controls, on the basis of the performance control information, the number of commands which are received from the host and are to be transmitted to the back end section so the present performance becomes the target performance.

10. The memory system according to claim 1,
wherein the back end section monitors a state of a buffer for read that temporarily stores read data read from the non-volatile memory unit, and controls, on the basis of the monitored state, an input of read commands which are received from the front end section to the parallel operating elements.

11. A memory system comprising:
a non-volatile memory unit; and
a memory controller that controls the non-volatile memory unit,
wherein the memory controller includes a front end section and a back end section, the front end section receiving commands from a host and returning responses to the commands to the host, the back end section receiving the commands from the front end section and accessing to the non-volatile memory unit in response to the commands,
the front end section monitors a number of the responses returning to the host within a predetermined time, and controls the return timing of the responses to the host so that the number of returning responses becomes target performance set in the memory system, and
the back end section controls the number of commands which are to be input on the basis of a target power consumption value.

12. The memory system according to claim 11,
wherein the non-volatile memory unit includes a plurality of parallel operating elements that are capable of being individually operated, and
the back end section includes power control information in which power consumption of the memory system is associated with the number of the parallel operating elements capable of being simultaneously operated, calculates a first element number which is the number of the parallel operating elements simultaneously operated and corresponds to the target power in the power control information, and controls an input of the commands to the parallel operating elements so that the number of the parallel operating elements simultaneously operated is equal to or smaller than the first element number.

13. The memory system according to claim 12,
wherein the back end section estimates present power consumption that includes a dynamic component of power consumption estimated on the basis of present performance of the memory system obtained from results of monitoring of the number of the responses returning to the host in the front end section or on the basis of the number of the parallel operating elements being presently and simultaneously operated in the memory system, and controls the input of the commands to the parallel operating elements using the estimated power consumption value on the basis of the power control information.

14. The memory system according to claim 12,
wherein the back end section further estimates leakage power of the power consumption according to temperature of the memory system, and estimates the present power consumption by adding the leakage power to the dynamic component of the power consumption.

15. The memory system according to claim 12,
wherein the parallel operating elements have a plurality of chips that are capable of being individually operated, respectively,
in the power control information, the power consumption of the memory system is associated with the number of the plurality of parallel operating elements capable of being simultaneously operated and the number of the plurality of chips capable of being simultaneously operated, and
the back end section controls the input of the commands to the plurality of parallel operating elements on the basis of the power control information so that the number of the plurality of parallel operating elements to be operated and the number of the plurality of chips to be operated are equal to or smaller than the number of the plurality of parallel operating elements simultaneously operated and the number of plurality of chips simultaneously operated, which correspond to the target power.

16. The memory system according to claim 15,
wherein the back end section estimates present power consumption that includes a dynamic component of power consumption estimated on the basis of present performance of the memory system obtained from results of monitoring of the number of the responses returning to the host in the front end section or on the basis of the number of the parallel operating elements being presently and simultaneously operated and the number of chips being presently and simultaneously operated in the memory system, and controls the input of the commands to the parallel operating elements using the estimated power consumption value on the basis of the power control information.

17. The memory system according to claim 16,
wherein the back end section further estimates leakage power of the power consumption according to temperature of the memory system, and estimates the present power consumption by adding the leakage power to the dynamic component of the power consumption.

18. The memory system according to claim 11,
wherein the back end section monitors a state of a buffer for read that temporarily stores read data read from the non-volatile memory unit, and controls, on the basis of the monitored state, an input of read commands which are received from the front end section to the parallel operating elements.

19. A method of controlling a memory system including a non-volatile memory unit and a memory controller, the memory controller including the front end section receiving commands from a host and returning responses to the commands to the host, and the back end section receiving the commands from the front end section and having access to the non-volatile memory unit in response to the commands, the method comprising:
queuing the commands which are received from the host in a queue of the front end section;
controlling, on the basis of target performance, the number of the commands which are transmitted to the back end section from the queue; and
controlling, on the basis of a target power consumption value, the number of commands which are to be input to the non-volatile memory unit.

20. The method according to claim 19,
wherein the controlling of the number of the commands that are transmitted to the back end section includes:
calculating a target value of the number of commands which stand by achieving the target performance by using performance control information in which performance of the memory system is associated with the number of the commands held in the queue; and
controlling, on the basis of the target value, the number of the commands which are transmitted to the back end section from the host.
